(19) United States
(12) Patent Application Publication
(10) Pub. No.: US 2003/0126013 A1
(43) Pub. Date: Jul. 3, 2003

(54) Viewer-targeted display system and method

(76) Inventor: Mark Alexander Shand, Dampierre-en-Yvelines (FR)

Correspondence Address: PENNIE & EDMONDS LLP, 3300 Hillview Avenue, Palo Alto, CA, 94304, US

(21) Appl. No.: 10/040,757

(22) Filed: Dec. 28, 2001

(51) Int. Cl. G06F 17/60

(52) U.S. Cl. 705/14; 345/700

(57) ABSTRACT

An information display system for targeting information to a plurality of viewers proximate to an information display includes at least one sensor for determining features of a subset of the plurality of viewers. The sensor(s) include at least a visual sensor for determining one or more physical features of the viewers, or an audio sensor for determining one or more audible features of the viewers. The information display system further includes a database comprising a plurality of information files, where each information file is targeted to at least one class of viewers associated with at least one physical feature or audible feature. An information file selection module selects one or more information files to display on the information display, based upon at least one determined feature of the subset of the plurality of viewers.

The present invention relates generally to information displays that display multiple information files, and in particular, to an information display that uses sensors to detect attributes of viewers proximate to the display for targeting information to those viewers.

### BACKGROUND OF THE INVENTION

Information displays, defined broadly to include any type of visual display that presents information for viewing, have always attempted to catch viewers' attention. Whether through an information-dispensing kiosk, a video presentation monitor, or an advertising billboard, these displays are only as effective as their ability to capture and hold the attention of passers-by. Thus, displays tend to be colorful, big (billboards), dynamic (video monitors), and interactive (kiosks). However, no matter how flashy these displays may be, if the information displayed is not pertinent or interesting to potential viewers, they are unlikely to pay attention. Further, in an era where the largest media activity is the effortless act of watching television, viewers are unlikely to interact with a display that requires a significant amount of complexity to obtain information. Thus, information displays tend to be hit-or-miss.

One type of information display, billboards, are typically found in public gathering spots or in areas of high concentrations of people, such as malls, train stations, airports, along highways, etc. Historically, billboards were only able to present a single, fixed image, and have thus been constrained both in the quantity of information presented, as well as the probability that the information presented is likely to be of interest to viewers. More recently, billboards are capable of showing a sequence of advertising or information in a time-sharing arrangement. This is useful because oftentimes billboards are found in areas where people are forced to wait for some period, such as a bus stop or a train station. By cycling through a series of advertisements or information, time-sharing billboards are better able to present a variety of diverse information, and hence are more likely to display an item of interest to any given potential viewer. However, the images displayed tend to be a fixed and repetitive set, and still might not be of interest to nearby viewers. Also, if a viewer were interested in a particular ad or bit of information, the viewer would only have the limited amount of time allocated in the time-sharing arrangement to absorb all of the information. In some instances, there may be more information than can be absorbed in a single presentation of the ad or image, and this may frustrate viewers.

In the cases where a user needs to obtain a specific set of information from a larger database, an interactive kiosk is a valuable tool. Through an interactive kiosk, a user can request very specific types of information. For example, a traveler at an airport could obtain a listing of all hotel, car rental, and transportation options within a specified price range at a specified distance from the airport, through a series of touch-button menus. However, even the most simple of kiosks can still present challenges to users, particularly those unfamiliar or fearful of interaction with computers. As such, many users who otherwise need the information might forego use of an interactive kiosk. Also, depending on how a kiosk is positioned and presented, a viewer may not understand that the kiosk has the particular information the viewer needs, and may thus not engage the kiosk on this basis. In general, kiosks face challenges both in attracting viewer attention, and in being simple enough for any potential user to operate.

One method that designers have used to attempt to overcome the drawbacks of kiosks is described in U.S. Pat. No. 6,256,046 B1, entitled “Method and Apparatus for Visual Sensing of Humans for Active Public Interfaces,” assigned to the present assignee, and the contents of which are hereby incorporated by reference. Further description of this functionality is found in: K. Waters, J. Rehg, M. Loughlin, S. B. Kang, and D. Terzopoulos, “Visual Sensing of Humans for Active Public Interface,” Digital Equipment Corp., CRL 96/5, March 1996, also incorporated herein by reference. In these documents, a “Smart Kiosk” is described that uses cameras to focus on separate zones surrounding the kiosk display to determine the presence or absence of viewers in the zones, their movement, and their three-dimensional spatial location.

To make these determinations, the Smart Kiosk uses computer vision, activity detection, color recognition, and stereo processing techniques. Using this information, the Smart Kiosk presents a computer-rendered human face that gazes directly at different viewers at different locations, even following them around as they are moving. The face can also greet the proximate viewers, communicating and behaving in a way that users can interpret immediately and unambiguously. While this type of simulated human interaction greatly increases the likelihood that a kiosk will capture the attention of nearby viewers, it does not provide any means to facilitate interactivity, nor does it provide a mechanism to target particular types of information or advertising to nearby viewers.

Another method of personalizing information and advertising for viewers is described in U.S. Pat. No. 5,740,549, entitled “Information and Advertising Distribution System and Method.” In this patent, Internet “push” technology is described, whereby a user self-selects the type of information the user wishes to obtain updates for, and the pertinent information is then “pushed” over the Internet to that user. The information is typically provided transparently to the user, generally when the user's terminal is otherwise idle. The user's self-selection of topics of interest also allows targeted advertising to be sent to the user along with the desired information. However, to receive self-selected information and targeted advertising, a user must register with a push provider, identify channels of information desired (generally based on a limited number of channels, like “sports,” “world news,” “weather,” etc.), and would still only view advertisements while actually reviewing the pushed information. Further, despite the fact that push technology was expected to be an important part of Internet usage, it has not been widely implemented or utilized.

Another Internet-based method of providing some level of personalization of information and advertising is through the use of “cookies.” A website may insert a “cookie” on a user's hard drive, which is information stored for future use by the website, typically identifying the user and recording the user's preferences. By storing and cataloging a historical record of a user's actions, a profile is built up that can be accessed by the website for targeting information and advertising to that user, based on the user's characteristics and preferences. However, creating this kind of a profile may require a user to take particular actions, i.e., visiting a particular website or specifying preferences for a website, which often does not provide the detailed clues necessary for accurate targeted advertising. Also, the profiles created are based on historical data, and are therefore not necessarily up-to-date for a particular user whose interests may dynamically change.

Therefore, it would be desirable to provide a system and method for improving the ability of information displays to attract viewers' attention by targeting information to the specific viewers nearby the information display.

### SUMMARY OF THE INVENTION

In one embodiment of the present invention, an information display system provides targeted information to a plurality of viewers proximate to an information display. The system includes at least one sensor for determining features of a subset of the plurality of viewers, including a visual sensor for determining one or more physical features of the viewers, or an audio sensor for determining one or more audible features of the subset. The system further includes a database of information files, where each information file is targeted to at least one class of viewers associated with at least one physical feature or audible feature. An information file selection module selects one or more information files to display on the information display, based upon at least one determined feature of the subset of the plurality of viewers.

In another embodiment of the invention, a viewer-targeted advertising system has a display for displaying advertisements to a plurality of viewers proximate to the display. The system includes at least one sensor of attributes of a subset of the plurality of viewers, including a visual sensor for sensing physical attributes of the subset, or an audio sensor for sensing audible attributes of the subset. A statistical modeling module determines one or more representative demographics of the viewers, where the representative demographics are associated with at least one of the attributes of the subset of the plurality of viewers. Additionally, the system includes a database of advertisements, where each advertisement is associated with at least one demographic. An advertisement selection module selects one or more advertisements from the database for displaying on the display for the plurality of viewers, where the advertisements are associated with the one or more determined representative demographics.

Another aspect of the present invention is a method for targeting advertising to a plurality of viewers proximate to an advertising display. The method determines one or more attributes of a subset of the plurality of viewers. The one or more attributes are selected from physical attributes and audible attributes of the viewers. The method also determines one or more representative demographics of the subset of the plurality of viewers, associated with at least one of the determined attributes of the viewers. Additionally, the method selects one or more advertisements from a database of advertisements, in accordance with the determined one or more representative demographics of viewers, and displays the one or more selected advertisements on the advertising display for the plurality of viewers.

### BRIEF DESCRIPTION OF THE DRAWINGS

Additional objects and features of the invention will be more readily apparent from the following detailed description and appended claims when taken in conjunction with the drawings, in which:

FIG. 1 is a block diagram of a system illustrative of one embodiment of the present invention.

FIG. 2 is a block diagram of a viewer-targeted advertising system, in accordance with an embodiment of the present invention.

FIG. 3 is a block diagram of a programmed general purpose computer that operates in accordance with one embodiment of the present invention.

FIG. 4 is a flow chart of a method of targeting advertising to a plurality of viewers proximate to an advertising display, in accordance with an embodiment of the present invention.

FIG. 5 is a block diagram of a central control and accounting system used, in one embodiment of the present invention, to update the advertisement or information content in a set of advertising or information display systems, and to retrieve and process advertisement or information display statistics.

### DETAILED DESCRIPTION OF THE PREFERRED EMBODIMENTS

Generally, a viewer-targeted advertising system is disclosed that presents targeted advertising to viewers nearby, or proximate, to an advertising display. The invention also applies to presenting targeted information to viewers proximate to an information display. (The terms “advertisement” and “information file,” and “advertising display” and “information display,” are used interchangeably in this specification). This occurs, in one embodiment, by monitoring physical attributes (or features) of the viewers nearby the advertising display in order to determine demographic information about the viewers. For example, viewers shorter than a threshold height may be presumed to be children, and viewers with longer hair may be presumed to be women. Of course, not all predictions are accurate.

The system also monitors for audible attributes (or features) of viewers, such as keywords or phrases that might be uttered concerning certain topics, as well as voice qualities like pitch and tone. For example, higher voices above a certain pitch may be presumed to be female, and the word “fashion” may be presumed to involve a discussion concerning clothing. From these physical and audible attributes, a representative demographic is statistically determined. In this sense, a “demographic” is not just a statistical category of human populations as used in, for example, a census, but applies more broadly to classifications, preferences, topics of interest, biases, and similar general characteristics of groups of viewers. The system contains a database of advertisements associated with specific demographics. By correlating the determined representative demographic to advertisements associated with related demographics, the system identifies and displays advertisements that are audience-specific to the viewers being monitored.

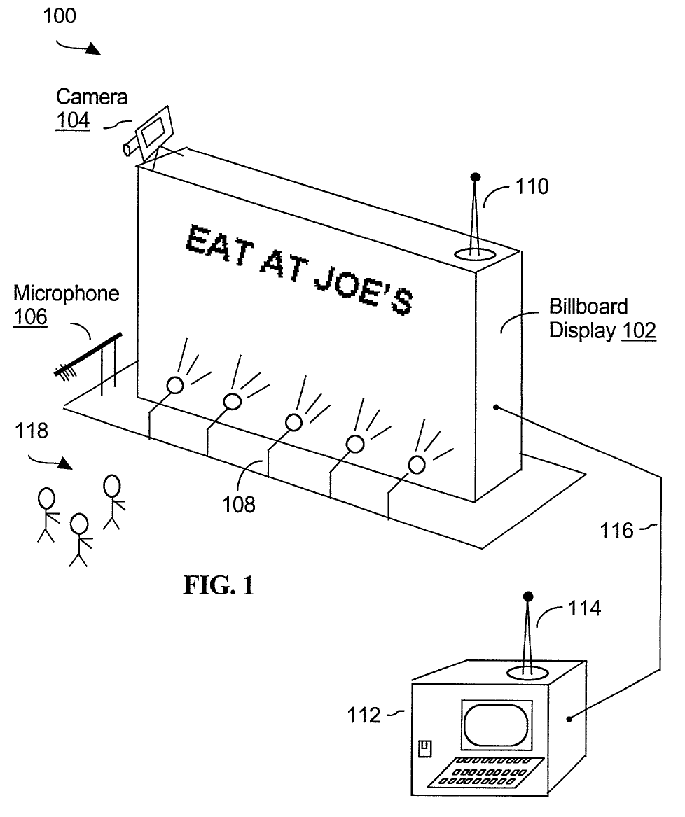

An illustration of a viewer-targeted advertising system in accordance with one embodiment of the present invention is shown in FIG. 1. Viewer-targeted advertising system 100 comprises a billboard display 102, camera 104, microphone 106, and computer 112. As shown, billboard display 102 is illuminated by lights 108, although in other embodiments, the billboard is self-illuminating through, for example, luminescence, a CRT, fiber optics, plasma technology, or any other display technology. The computer 112 may be integrated into billboard display 102 (not shown), or connected through a network over communications link 116. The billboard display may also communicate with the billboard display through wireless communications, over antennae 110 and 114.

Camera 104 records visual activity in an area surrounding the billboard 102, which, as shown in FIG. 1, would include the activities of proximate viewers 118. The camera 104 senses visible, physical attributes of the proximate viewers 118, or a subset of them, which is also referred to as determining one or more physical features of the proximate viewers. The boundaries of the area recorded by the camera can be defined and/or adjusted by changing the position of the camera, angle of focus of the camera, lens angle, focal length, and the like. Also, while only one camera is shown, multiple cameras can be utilized, with each camera recording visual activity in a different zone surrounding the billboard display 102. Using a greater number of cameras increases the visual footprint monitored around the billboard 102, and hence the number of proximate viewers monitored for physical attributes.

While billboard 102 is shown with camera 104 mounted on the upper left corner of the billboard (not to scale), the camera can be positioned anywhere on or near the billboard. For example, the body of camera 104 could be integrated into the billboard 102 such that it is invisible to viewers 118, with only an opening for the camera aperture located at the surface of the billboard. Also, the camera 104 could be entirely independent of the billboard —for example, the camera could be mounted at a position in front of the billboard on a different structure, such as a nearby streetlight or bridge. This would allow the viewer-targeted advertising system 100 to monitor from a completely different angle than the camera 104 as shown. Also, cameras could be mounted fore, aft, and to the sides of the billboard display 102, allowing for multiple zone monitoring. Or, the zones monitored from different positions could overlap and/or be identical, such that the same zone is visually monitored from different angles so that physical features can be more distinctly discerned, or determined in three dimensions.

While FIG. 1 shows the use of a camera, any type of visual sensor can be used in accordance with the present invention. For example, motion detectors, infrared sensors, rangemeters, night-vision cameras, or any other type of electromagnetic sensor may be utilized independently, or in combination with a standard optical camera. Different types of visual sensors allow for different functionality, such as the ability to monitor nighttime activity using a night-vision camera. In one embodiment, the visual sensor has recording capability for storing images to allow for post-processing of scenes, although the lag time (e.g., processing of the stored image or images within a time period of less than a minute) cannot be too great or the proximate viewers being monitored may change topics of conversation, or may leave the area. In another embodiment, the signal processing occurs in substantially real-time, ensuring that dynamically changing features and attributes of proximate viewers are used to rapidly and appropriately target advertising.

Billboard display 102 also includes microphone 106, which senses audible attributes of proximate viewers 118, or a subset of them, also referred to as determining one or more audible features of the subset of the proximate viewers. The illustrative microphone 106, mounted on the lower left base of the billboard 102, can actually be multiple microphones, such as an array of microphones. The microphones can be mounted at any location on billboard 102, or scattered around the billboard, or on structures proximate to the billboard, such as a nearby streetlight or bridge. In one embodiment, the microphones are mounted at head-level so as to best capture conversations. The type of audio sensor used by the billboard display 102 can constitute a variety of different types of audio sensors, such as dynamic or condenser microphones. The audio sensor can be an omnidirectional microphone, positioned to cover the same space monitored by the visual sensors of the billboard in one embodiment, or greater or lesser area in another. Also, a directional microphone can be used as the audio sensor to cover certain “sweet spots,” where conversation may be particularly important, such as on a corner by the walk button on a traffic-light pole.

Like with camera 104, microphone 106 has recording capability for recording conversations for post-processing in one embodiment, although the processing must occur fairly close in time (e.g., within a time period of less than a minute) to when the conversation occurs to ensure that the advertising is accurately targeted to the proximate viewers. In another embodiment, the audio signal processing occurs in substantially real time.

Computer 112 includes a database of information files or advertisements. It also contains modeling and selection modules, discussed below, which match physical and audible attributes with representative demographics in order to identify the appropriate information file or advertisement to display on billboard display 102. The computer 112 may be integral to the billboard 102, or it may communicate with the billboard over communications link 116, or through wireless antennae 114 and 110. If the computer 112 is remote from the billboard, it can be used to control multiple billboards from a centralized location. This allows greater control over advertising content, in that advertisements can be easily updated or replaced for an entire system of viewer-targeted billboard displays. Alternatively, if the computer 112 is located locally at the billboard display 102, centralized control over an entire system of viewer-targeted billboard displays can still be achieved by networking together the computers 112 themselves. In this manner, a central control station can still control the advertising content of the billboard displays 102 in the system by downloading new content to the individual computers 112, and directing the computers 112 to erase old content from their databases, as appropriate.

Furthermore, the central control station may collect advertisement display statistics, indicating how often each advertisement was displayed by each of the individual billboard displays 102. Such statistics may include additional information, such as the time of day the advertisements were displayed, the number of viewers the system detected as being in the vicinity of the system at the time of each playing of each advertisement, the total number of detected viewers of each advertisement in the system's advertisement database, and so on, and these statistics may be used to determine the amount of revenue to be charged the advertisers. Also, by providing the advertisers statistical information on how often their advertisements were displayed, or the number of viewers detected nearby when their advertisements were displayed, a kind of rough “feedback” can be established, helping the advertisers gauge the effectiveness of their advertisements.

For billboard displays equipped with audio sensors, the effectiveness of the targeted advertising can be determined, in part, by monitoring the effect of an advertisement on subsequent conversation. For example, after an advertisement has been displayed, new keywords and phrases captured from the audience can be compared with keywords and phrases statistically expected to be elicited by the advertisement. Through this type of analysis, the ability of an advertisement to gain viewers' attention, as well as the viewers' impressions of the advertisement, can be monitored, with a goal of improving overall targeting accuracy and advertising quality.

If the database of advertisements of computer 112 is centrally located, the modeling and selection functionality either can be located at the centralized computer location with the database, or it can be located locally at each individual billboard (e.g., as part of a separate computer that is integrated with the billboard display 102). If the modeling and selection functionality is located centrally, the matching of specific attributes and representative demographics can be easily and dynamically adjusted for an entire system of viewer-targeted billboard displays. Centralized adjustment of modeling and selection functionality can be used to rapidly reflect, for example, empirical data on the accuracy of the targeted advertising. However, centralized modeling and selection functionality requires that all sensed physical and audible attributes be transmitted to the central location for processing, potentially causing some lag time in the dynamic targeting of advertising to nearby viewers of each individual billboard display 102.

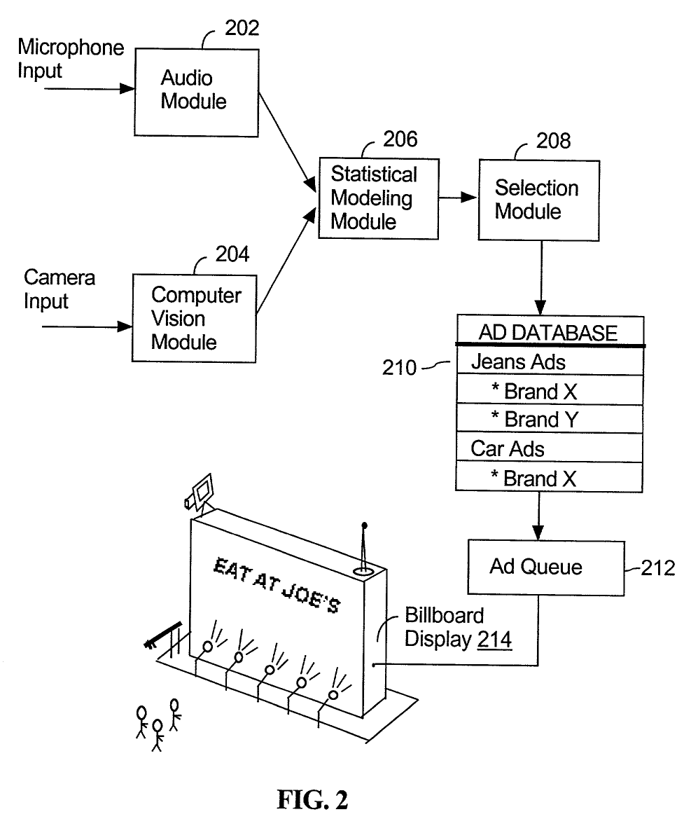

Referring to FIG. 2, further detail on the viewer-targeted advertising system of FIG. 1 is shown. Microphone input from the audio sensor(s) is provided to audio module 202, which may be integral to the audio sensors, or may be a physically distinct component. Audio module 202 processes the signal from the audio sensors to generate audible attributes of a subset of the viewers proximate to the billboard display. Audible attributes generally fall under two categories: words spoken and voice qualities. To determine words spoken, in one embodiment, an array of microphones separates and extracts various sound sources impinging on the microphone array. This is achieved by using Blind Source Separation (“BSS”), an established audio signal processing technique that recovers the original waveforms of audio sources from a mix of several source signals, detected by several sensors. No knowledge of the mixed audio-source structure is necessary to arrive at the separate sources. By separating out voice sources, the audio module 202 can then convert separate speech patterns into text, through speech recognition techniques and/or speech-to-text converters. This aspect of the present invention can be implemented using conventional speech recognition techniques and/or speech-to-text conversion techniques, or may be implemented using speech recognition techniques and/or speech-to-text conversion techniques that may be developed in the future.

From the identified speech patterns, the audio module 202 can identify predetermined keywords and phrases. (The terms “keywords” and “phrases” are meant to be interchangeable as used herein—a “phrase” could consist of one or more “keywords”). The audio module 202 does this by maintaining, or accessing, a list of predefined keywords and phrases, and then monitoring for the occurrence of those particular terms. Alternatively, the audio module 202 can maintain, or access, a list of “noise” words to filter out, leaving only important words for further processing, such as keyword determination.

Both the speech-to-text conversion techniques utilized, as well as the predefined keywords and phrases being monitored for, may include more than one language to ensure that the billboard displays accurately target advertising to viewers in multi-lingual regions. This may be especially useful in bilingual areas like the southwestern United States, where both Spanish and English are commonly spoken, or in multi-lingual Europe.

Through BSS, the audio module 202 can also determine sound source location information. Using this sound source location information, the audio module can then cluster together sets of separate voice sources in close physical proximity, representing different groups among the proximate viewers. By identifying clustered sets of voice sources, each set can be treated as a single source for purposes of monitoring for predetermined keywords or phrases. This ensures that, in one embodiment, proper weighting is given to the identified keywords and phrases by the statistical modeling module 206. This is important because the statistical modeling module 206 determines a representative demographic based, in part, on keywords and phrases provided by the audio module. For example, if similar keywords or phrases are identified from different clustered sets of voice sources (i.e., multiple groups are talking about the same subject), the likelihood that a representative demographic associated with the similar keywords and phrases accurately represents the interests of all viewers greatly increases. In another embodiment, keywords and phrases are not used to determine a representative demographic, but rather are directly matched up with advertisements or information files having similar associated keywords and phrases. This embodiment is described in further detail below.

In an embodiment having both audio and visual sensors, and where the audio module 202 clusters together sets of voice sources, computer vision module 204 identifies the approximate number of persons corresponding to each clustered set of voice sources using image processing. This information is provided to statistical modeling module 206 to further assist in statistical weighting of the representativeness of identified keywords and phrases for the entirety of the viewers of the billboard display. For instance, identified keywords or phrases uttered by a large group carry greater statistical significance than keywords and phrases identified from voice sources from a smaller group.

In addition to determining words spoken, audio module 202 also determines audible attributes pertaining to voice qualities. It does this by processing the audio signal from the audio sensors to determine certain tonal and vocal qualities. For example, in one embodiment, audio module 202 conducts a Fourier analysis (such as a “Fast Fourier Transform,” or “FFT”) on the signal to determine the pitch (frequency) of a speaker's voice, and also analyzes the loudness (amplitude) of the speaker's voice. With this information, the statistical modeling module 206 can predict, for example, whether a speaker is likely to be a man or woman (depending on pitch), whether a speaker is generally aggressive or mild-mannered (based on loudness of speech), and whether a speaker is likely to be older or younger (based, for example, on whether the person is speaking quickly or slowly, which may be determined by the average time between words as well as the pace at which the words themselves are spoken).

As further shown in FIG. 2, the camera input from the billboard display is provided to computer vision module 204. Computer vision module 204 can be either integral to the visual sensor(s), or be physically distinct from them. It uses computer vision technology to digitize and process the signal received from the visual sensors to generate physical attributes of groups, or subsets, of the viewers proximate to the billboard display. Computer vision technology allows a computer to compute properties of the three-dimensional world from digital imagery, and may include functionality such as activity detection, stereo processing, and color recognition. For example, activity detection through image differentiation and motion sensing can identify individual viewers. Stereo motion tracking, in combination with triangulation, can provide an approximate location of a viewer relative to the billboard, as well as motion vectors for the viewer. Color recognition can provide details on, for example, clothing, make-up, ethnicity, eyeglass wear, hair color, and the like. Thus, through these techniques, different people can be identified, located, and characterized by their clothing and/or other physical features. Computer vision techniques may also provide basic parameter determination like viewers' height and weight.

Because deriving physical attributes from images can be imprecise, even with sophisticated computer vision technology, probabilistic logic may also be used to help predict certain attributes. While this type of functionality is more typically part of the statistical modeling module 206, as described below, it may also be integrated into the computer vision module 204. As an example, probabilistic logic may be employed to help determine a person's weight, using body shape and density values for various types of people to make a general, predictive determination.

In one embodiment, the computer vision module 204 can detect very subtle physical attributes of the viewers proximate to the billboard display, such as emotion or general attitude. This may be determined, for example, by facial processing and recognition logic that can detect general traits like nervousness (e.g., looking around rapidly), general pleasure (e.g., upturned mouth, laughing), general unease or unhappiness (down-turned mouth, tensed facial muscles), and the like. By determining moods or dispositions of viewers proximate to the billboard, the billboard can display advertising conveying the appropriate tone. For example, serious or negative-tone advertising may be inappropriate or ineffective when presented to a group of viewers engaged in laughter.

The physical attributes generated by the computer vision module 204 are provided to statistical modeling module 206, which uses the information to make certain predictions. For example, statistical modeling module 206 may predict whether a viewer is old or young (by height), whether a viewer is a man or a woman (by lip color and upper eyelid color, which are more likely to be colored for women), whether a viewer prefers casual or formal clothing (a person in a suit may be more interested in business attire), etc. In one embodiment, this predictive statistical modeling is combined with determinations based on audible features to generate a representative demographic in a manner that will be described next.

Based upon the audible attributes of subsets of the proximate viewers provided by audio module 202, and/or the physical attributes of the subsets provided by the computer vision module 204, statistical modeling module 206 chooses a representative demographic for the plurality of viewers proximate to the billboard display. In one embodiment, a representative demographic is a general classification or category that best describes or characterizes the average features of a group of viewers. It is important to note that this classification is predictive. It is perfectly acceptable for the system to make incorrect classification predictions some of the time (e.g., up to, say, 50% of the time), as long as it makes correct classification predictions sufficiently often so as to present advertisements or other information that is of interest to the viewers more often than a system which merely cycles through a fixed schedule of advertisements or information displays without attempting to determine any features or demographics of the viewers currently in the vicinity of the system.

An example of a predictive classification of a plurality of viewers may be that they are a group of approximately middle-age business men. This classification is merely predictive, due to the limitations of computer sensing and processing technology. However, this predictive classification could be based upon a combination of sensed attributes that makes the prediction reasonably likely to be correct. Such a combination of sensed attributes may include, for instance, average heights above a threshold level associated with men, clothing of a shape and color consistent with suits, relatively deeper voices, relatively shorter hair, skin texture consistent with some wrinkling, hair color consistent with some greying and/or receding hairline, as well as keywords uttered including “meeting,” “sales,” “marketing,” etc. These attributes are merely illustrative, and many other types of attributes could also be relied upon.

In other instances, the predictive representative demographic does not follow directly from the sensed attributes. For example, a subset of proximate viewers sensed to be relatively taller, with blonde-hued hair and mid-range voices, could either be a group of blonde men with somewhat higher-pitched voices than average, or it could be a group of statistically taller-than-average blonde women with somewhat lower-pitched voices than average. This predictive determination is best made using Bayesian logic, described next, and is likely to be more accurate if additional sensed attributes can be determined, such as facial color suggestive of make-up or jewelry.

To make representative demographic determinations, the statistical modeling module 204 uses, in one embodiment, Bayesian logic, as is well known by those of skill in the art. Bayesian logic is branch of logic applied to decision making and inferential statistics that deals with probability inference—using the knowledge of prior events to predict future events. Based on probability theory, Bayes' theorem (named after English mathematician Thomas Bayes) defines a rule for refining a hypothesis by factoring in additional evidence and background information, and leads to a number representing the degree of probability that the hypothesis is true. In other words, Bayes' theorem quantifies uncertainty, which is particularly advantageous in the context of the present invention. Statistical modeling module 206 uses this Bayesian logic number, or statistical weighting, to determine which potential demographic, or combination of potential demographics, constitutes the most accurate representative demographic of the proximate viewers, based upon the sensed physical and audible attributes.

Furthermore, the sensed physical and audible attributes themselves may have more than one interpretation. For example, a light-hued hair color could be deemed to be either a light blond color or a pigmented grey color. Bayesian logic, in combination with other related attributes and empirical statistics, provides a statistic weighting value for the probability of each interpretation being true. The statistical modeling module 206 uses this information to determine the most probable interpretation, which is then further used in combination with other attributes to formulate the most accurate representative demographic for the proximate viewers.

In addition to Bayesian logic, the statistical modeling module 206 may also use heuristic logic to determine which potential demographic, or combination of potential demographics, constitutes the most accurate representative demographic of the proximate viewers. This ad hoc approach, while less structured than a Bayesian logic approach, may still prove to be useful, particularly where the correlation between certain attributes and representative demographics dynamically changes. Importantly, any other type of probabilistic, statistical, hierarchical, modeling, or weighting logic known to those of skill in the art can be used by statistical modeling module 206, and is meant to be encompassed within the scope of the invention.

In one embodiment, the representative demographics are not a classification of the actual demographics of a group, in the sense of demographics of human populations, but are more directed toward predicted preferences of the group. For example, a representative demographic may be that a particular group prefers upscale or formal clothing, based on the colors and type of clothing they are currently wearing, as sensed by the visual sensors. Suits, dark-colored urban wear, full-length dresses, and similar clothing may lead the statistical modeling module 206 to determine that the appropriate representative demographic is that the proximate viewers prefer upscale or formal clothing. The actual demographics of the group, such as whether they are younger or older, business persons or just casual shoppers/passers-by, is less important than predicting that the viewers might be interested in advertising displaying upscale or formal clothing.

Once the statistical modeling module 206 determines a representative demographic for a plurality of proximate viewers, selection module 208 uses this representative demographic to select one or more advertisements from the advertisement database 210. In one embodiment, the advertisements in the advertisement database 210 are each associated with at least one demographic, which represents the type of persons most likely to be interested in the advertisements. For example, advertisements directed to “hip-hop” style clothing will be most appealing to a teen-age or young-adult audience, and advertisements directed to retirement financial planning will be most appealing to a more mature audience. Similarly, certain products can be ethnicity- or gender-typed. The correlation of certain products and certain demographics is well-established in the advertising industry, which tends to place advertising in media sources based upon the demographics that view the particular media sources. Thus, using these well-established advertising targeting protocols, the advertisements can be associated with one or more demographics.

In one embodiment, the associated demographics for the advertisements in the advertisement database 210 are not the type of persons most likely to be interested in the advertisements, but instead are a summation of the content or subject matter of the advertisement, such as “car ad,” “jeans ad,” “financial planning ad,” etc. By categorizing the advertisements or information files in the database 210, a representative demographic indicating preferences (i.e., “interested in cars”) can readily be used to select the appropriate advertisement.

The actual information reflecting the association between advertisement and demographic is stored along with each advertisement in the advertising database 210 in one embodiment, or in a look-up table in selection module 208 itself, in another. Additionally, in another embodiment, no predetermined associated demographic for each advertisement is utilized; instead, the selection module 208 heuristically or probabilistically determines the best advertisement to display based on the representative demographic. A rules-based engine (not shown) may also be utilized to make this determination.

In another embodiment, the advertisements are not associated with demographics. In this embodiment, at least some of the advertisements in database 210 are associated with keywords and phrases. The associated keywords and phrases can be determined by a parser, which automatically identifies the keywords and phrases associated with each advertisement by parsing through it and locating keywords and phrases, or screening out “noise” words. Alternatively, specific keyword or phrase content can be provided by the originator of an advertisement or information file, either in a separate document, or associated with the advertisement or information file directly, as part of the same record. In this embodiment, audio module 202 extracts speech patterns from voice sources impinging on the audio sensors, and converts the speech patterns to text using speech-to-text conversion technology. Instead of determining representative demographics, the statistical modeling module 206 compares the converted text against a list of keywords and phrases associated with the advertisements in database 210.

When keywords or phrases are identified in the converted text that are similar to keywords and phrases associated with one or more advertisements, the selection module 208 selects the corresponding one or more advertisements from database 210. In one embodiment, selection module 208 has keyword filtering logic to determine which advertisement or advertisements to select when multiple keywords or phrases are identified in the extracted speech patterns. The keyword filtering logic may also be located in the statistical modeling module 206, or split between the statistical modeling module 206 and the selection module 208. In one embodiment, determining which advertisement or advertisements to select when multiple keywords or phrases are identified occurs using statistical modeling, such as Bayesian logic, to determine representative keyword(s) and/or phrase(s) that correspond to the topics of conversation among the greatest number of people. These representative keywords and phrases may also be considered representative demographic(s). In other embodiments, the list of identified keywords and phrases is organized in a hierarchy, such that certain keywords and phrases take precedence over others in determining which advertisement are selected.

Like with multiple keywords, oftentimes a representative demographic may correlate to multiple advertisements. Depending on the number of corresponding advertisements, the selection module 208 can either select all of the multiple advertisements for display, or may conduct filtering to determine which advertisements among the possibilities will be displayed. The filtering can, like the prediction of representative demographics, be accomplished through statistical modeling, such as Bayesian logic, in order to determine the best advertisement to display to appeal to the greatest number of viewers. Alternatively, the advertisements can be prioritized in a hierarchy of presentation. In this case, the order of presentation could be determined by, among other things, the price the advertiser has paid to display its advertisement. Also, other types of rules-based relationships and algorithms for presentation can be employed, as known by those of skill in the art.

Regardless of the manner chosen, once an advertisement is selected, it is loaded from the database into an advertisement queue 212. The advertisement resides in the queue until it is distributed to billboard display 214, whether by wire or over wireless antennae. The queue contains a set of advertisements to be displayed, generally on a first-in, first-out basis, with additional advertisements being added to the queue as additional attributes or features are sensed. New attributes or features may indicate that new viewers are proximate to the billboard display 214, or may reflect a shift in the topics of conversation among viewers. Also, advertisement queue 212 has logic to remove queued advertisements if they are no longer relevant to the viewers proximate to the billboard display 214, such as when viewers leave the area. The length of time that a particular advertisement spends in the queue is a function of the number of other advertisements ahead of the advertisement, and the average amount of time that an advertisement is displayed on the billboard display 214 in a time-sharing arrangement. The amount of time an advertisement is actually displayed can be determined by, among other things, the amount of money an advertiser has paid to display its advertisement.

In one embodiment, the advertisement queue 212 is populated by the system in part with advertisements from a fixed, predetermined schedule of advertisements and in part with advertisements selected in accordance with the determined viewer demographics or viewer features. For instance, advertisements from the predetermined schedule may be interleaved with advertisements selected in accordance with predicted viewer interests. In another instance, the system populates the advertisement queue 212 with advertisements from the predetermined schedule when it is unable to sense the presence of any viewers, or is unable determine any viewer demographics or viewer features with a probability exceeding a predefined threshold. In yet another variation, advertisements randomly selected from an advertisement database are intermixed with advertisments selected based on predicted viewer demographics or features. The random selection of advertisements may be weighted in accordance with specified weights, where the weights control the average frequency that each advertisement is randomly selected. The weights may be based on the amounts paid by the advertisers or other criteria. Weighted random selection of advertisements varies the order in which they are presented, which may be advantageous in some settings. Various other methodologies may be used for mixing advertisements from a predetermined schedule and/or randomly selected advertisements with advertisements selected in accordance with predicted or determined viewer demographics or features.

In some embodiments, the advertisement queue 212 is, like the advertisement database 210, located in a central location. In this case, each billboard display 214 would preferably have its own advertisement queue, or portion of a queue, at the central location. Otherwise all remote billboard displays will end up displaying the same advertisement at the same time (which may also be desirable under certain circumstances). Alternatively, the advertisement queue 212 could be located remotely at each individual billboard display, while the database of advertisements 210 remains centralized. The advantage of this arrangement is that the delay in transmitting advertisements from the centralized database 210 to the local advertisement queue 212 is not seen by the viewers, as the newly-arriving advertisements are immediately cached, and not displayed. In other embodiments, there is no advertisement queue 212; instead, selection module 208 outputs advertisements from the advertisement database 210 at the precise time the advertisement is being displayed on the billboard display 214.

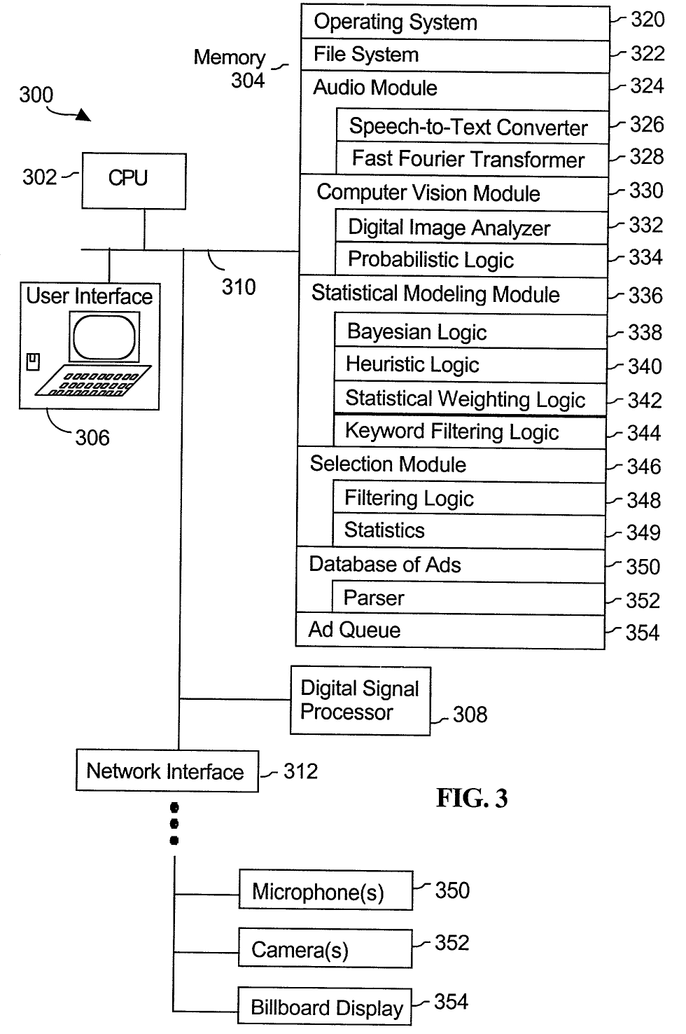

Referring to FIG. 3, a general computer system 300 capable of practicing the present invention is shown. Computer system 300 contains one or more central processing units (CPU) 302, memory 304 (including high speed random access memory, and non-volatile memory such as disk storage), an optional user interface 306, and a digital signal processor 308, all of which are interconnected by one or more system busses 310. The computer system 300 is also connected to a network through a network interface 312. Microphone(s) 350, camera(s) 352, and billboard display 354 are also connected to the network, which may comprise a Local Area Network if the computer system 300 is located locally at a billboard display, or may comprise a Wide Area Network or the Internet if the computer system 300 is located centrally. If the general computer system 300 is centralized, there may be many instances of microphone(s) 350, camera(s) 352, and billboard display 354 connected to the network. As discussed previously, the network can be wired or wireless. In other embodiments, such as self-contained display systems, the microphone(s) 350, camera(s) 352, and billboard display 354 may be connected to the other components of the system by system busses 310.

The memory 304 typically stores an operating system 320, file system 322, audio module 324, computer vision module 330, statistical modeling module 336, selection module 346, database of ads 350, and ad queue 354. In addition, audio module 324 may include one or both of speech-to-text converter 326 and fast Fourier transformer 328, or any other type of audio signal processing technology. Also, computer vision module 330 may include one or both of digital image analyzer 334 and probabilistic logic 334, or any other type of visual signal processing technology. Further, statistical modeling module 334 may include one or more of Bayesian logic 338, heuristic logic 340, statistical weighting logic 342, and keyword filtering logic 344, or any other type of probabilistic, statistical, hierarchical, modeling, or weighting logic. Finally, the selection module 346 may include filtering logic 348, and the database of ads 350 may include a parser 352.

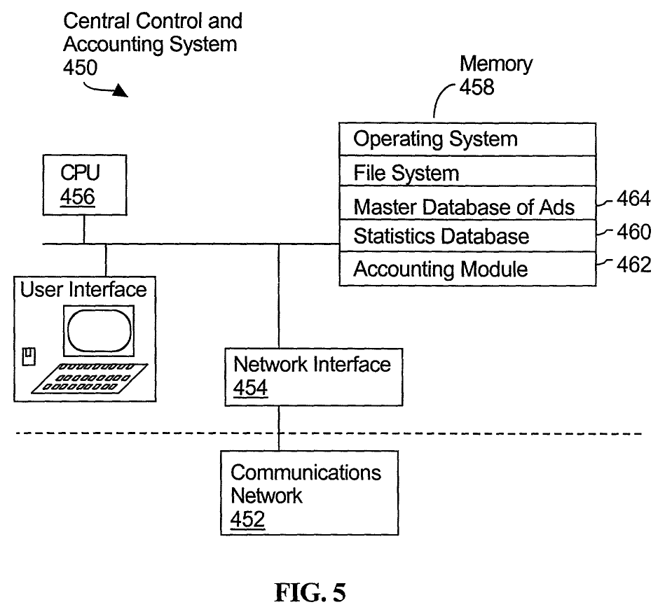

In one embodiment, the selection module 346 maintains advertisement selection and viewing statistics 349. These statistics 349 indicate how often each advertisement was displayed by the system 100. The statistics 349 may also include additional information, such as the time of day the advertisements were displayed, the number of viewers the system detected as being in the vicinity of the system at the time of each playing of each advertisement, the total number of detected viewers of each advertisement in the system's advertisement database, the extracted viewer attributes that caused the advertisement to be selected for display, and so on. These statistics may be conveyed by the network interface 312 to an accounting system or other central computer system (shown in FIG. 5 as system 450), and then used to determine the amount of revenue to be charged the advertisers.

Many of the features of the present invention are not necessarily distinct applications. For example, statistical modeling module 336 and selection module 346 can be implemented using a single software application that implements their joint functionality. Similarly, database 350 and ad queue 354 can be combined to operate as one functional entity. Also, while memory 304 is shown as physically contiguous, in reality, it may constitute separate memories. For example, memory 304 may include one or more disk storage devices and one or more arrays of high speed random access memory. The various files and executable modules shown in FIG. 3 may be stored in various ones of these memory devices, under the control of the operating system 320 and/or file system 322.

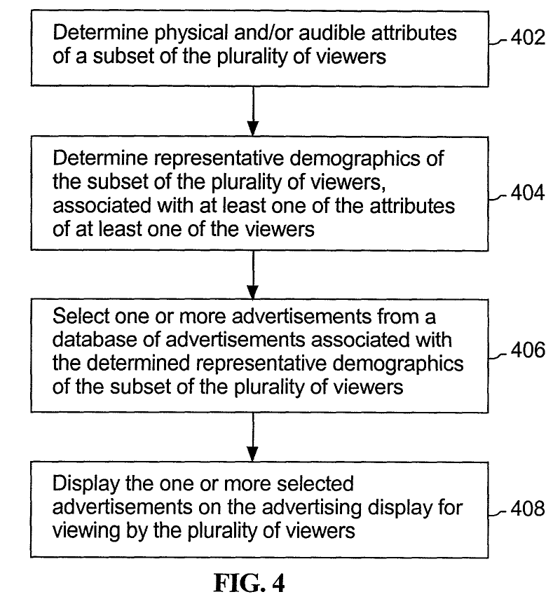

Referring to FIG. 4, a method for targeting advertising to a plurality of viewers proximate to an advertising display is shown, in accordance with one embodiment of the present invention. The method determines physical and/or audible attributes of a subset of the plurality of viewers (402). As explained above in detail, the physical and audible attributes of the nearby viewers are sensed through visual and audible sensor(s), respectively. Next, the method determines representative demographics of the subset of the plurality of viewers, associated with at least one of the attributes of at least one of the viewers (404). Again, as explained above, the statistical modeling module, using Bayesian logic in one embodiment, makes predictive classifications of the plurality of viewers in the form of representative demographics.

Next, the method selects one or more advertisements from a database of advertisements associated with the determined representative demographics of the subset of the plurality of viewers (406). The selection module makes this selection, in one embodiment, by matching up the determined representative demographics with the demographics associated with a particular advertisement or set of advertisements. Finally, the method displays the one or more selected advertisements on the advertising display for viewing by the plurality of viewers (408).

FIG. 5 shows a central control and accounting system 450 which is used in embodiments in which the content of the advertising or information file database of the display systems 100 is controlled by a central system 450 via a communications network.452. The network 452 may be the Internet or other wide area network, an intranet, a local area network, a wireless network, or a combination of such communication networks. The central system 450 may be any suitable type of computer system, most of the details of which are not important to the present discussion. The central system 450 preferably includes a network interface 454 for communicating with the display systems via the network 452, one or more processing units 456 for executing programs, and memory 458 (including high speed random access memory, and non-volatile memory such as disk storage), for storing programs and data. The memory 458 preferably stores statistical information 460 obtained from the display systems, as discussed above, and an accounting module 462 for processing the statistical information. For example, the accounting module 462 is preferably configured to determine amounts to be paid by advertisers, based on how many times particular advertisements were displayed and/or based on the number of detected viewers of each advertisement. The accounting module 462 may also be configured to analyze the collected statistics so as to generate secondary statistics indicating which advertisements are most often and least often selected, and which viewer demographics or features are most often and least often detected. The secondary statistics may then be used to adjust the set of advertisements or information files stored in or used by the various display systems 100, selecting the advertisements or information files to be stored in or used by each display system from a master database 464.

While the viewer-targeted advertising system of the present invention is intended to monitor attributes and present targeted advertising discreetly, if a viewer were aware of its operation, the viewer could actually voice keywords or phrases to attempt to bring up related advertising of interest. However, one aspect of the present invention is that it monitors the attributes and features of the proximate viewers even when viewers are not taking purposeful action to direct the selection of particular information files or advertisements. Also, it is generally not desirable for the viewer-targeted advertising system to build up a historical record of attributes and features of proximate viewers over time because the viewers are likely to change many times over the course of a day, and thus the set of attributes and features of the viewers will often be very dynamic and fluid. Thus, in one embodiment, the determination of the representative demographics and selection of corresponding advertisements occurs substantially contemporaneously (e.g., within one minute of the time the viewer features are observed by the system's sensors).

In one embodiment, the billboard display is sub-divided into separate viewing areas. In this case, the monitoring of attributes and features occurs in zones, whereby separate representative demographics are determined for viewers in the separate zones, and separate corresponding advertisements or information files are displayed in each separate viewing area of the billboard display. In this manner, those persons closest to a particular portion of the billboard can see information files or advertising targeted just to themselves, allowing for an even greater likelihood that the displayed advertisement or information file will be of interest.

The present invention can also be implemented as a computer program product that includes a computer program mechanism embedded in a computer readable storage medium. For instance, the computer program product could contain the audio module, computer vision module, statistical modeling module, selection module, database of ads, and ad queue shown in FIG. 3. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. An information display system for targeting information to a plurality of viewers proximate to an information display, the system comprising:
at least one sensor for determining features of a subset of the plurality of viewers, comprising at least one of:
a visual sensor for determining one or more physical features of the subset of the plurality of viewers; and
an audio sensor for determining one or more audible features of the subset of the plurality of viewers;
a database comprising a plurality of information files, each information file of the plurality of information files being targeted to at least one class of viewers associated with at least one of a physical feature and an audible feature;
an information file selection module for selecting one or more of the information files to display on the information display, based upon at least one determined feature of the subset of the plurality of viewers.

2. The information display system of claim 1, wherein the at least one sensor is configured to determine one or more of the features of the subset of the plurality of viewers even when the subset of the plurality of viewers are not taking purposeful action to direct the information file selection module to select the one or more information files.

3. The information display system of claim 1, wherein the one or more information files are displayed on the information display substantially contemporaneously with the determination of one or more of the features of the subset of the plurality of viewers.

4. The information display system of claim 1, wherein the one or more determined audible features include one or more words spoken by at least one viewer of the subset of the plurality of viewers.

5. The information display system of claim 4, further comprising a speech-to-text converter for converting the one or more words spoken to text, and wherein the information selection module compares the converted text against a list of keywords in conjunction with selecting the one or more information files to display.

6. The information display system of claim 1, wherein each information file in a subset of the plurality of information files in the database have associated keywords.

7. The information display system of claim 6, further comprising a parser for automatically identifying the associated keywords for each information file in the subset of the plurality of information files.

8. An information display system for targeting information to a plurality of viewers proximate to an information display, the system comprising:
one or more audio sensors for determining one or more words spoken by at least one viewer in a subset of the plurality of viewers;
an audio processing module for converting the determined one or more words spoken into text, and for identifying keywords in the converted text;
a database comprising a plurality of information files, each information file having associated keywords; and
an information file selection module for selecting one or more information files to display on the information display, based upon similarity between one or more of the identified keywords in the converted text, and one or more of the associated keywords of the one or more information files;
wherein the one or more audio sensors are configured to determine the one or more words spoken by at least one viewer in the subset of the plurality of viewers, even when the subset of the plurality of viewers are not taking purposeful action to direct the information file selection module to select the one or more information files.

9. A viewer-targeted advertising system having a display for displaying advertisements to a plurality of viewers proximate to the display, the system comprising:
at least one sensor of attributes of a subset of the plurality of viewers, comprising at least one of:
a visual sensor for sensing physical attributes of the subset of the plurality of viewers;
an audio sensor for sensing audible attributes of the subset of the plurality of viewers;
a statistical modeling module for determining one or more representative demographics of the subset of the plurality of viewers, the one or more representative demographics being associated with at least one of the attributes of the subset of the plurality of viewers;
a database comprising a plurality of advertisements, each advertisement of the plurality of advertisements being associated with at least one demographic; and
an advertisement selection module for selecting one or more advertisements from the database for displaying on the display for the plurality of viewers, the one or more selected advertisements being associated with the one or more determined representative demographics.

10. The viewer-targeted advertising system of claim 9, wherein the statistical modeling module is configured to determine the one or more representative demographics even when the subset of the plurality of viewers are not taking purposeful action to direct the selection of advertisements.

11. The viewer-targeted advertising system of claim 9, wherein the statistical modeling module and the advertisement selection module are configured to substantially contemporaneously determine the one or more representative demographics and select the one or more advertisements, respectively.

12. The viewer-targeted advertising system of claim 9, wherein the statistical modeling module and the advertisement selection module are configured to work together so as to select the one or more advertisements based on contemporaneously sensed attributes of the subset of the plurality of viewers currently proximate to the display.

13. The viewer-targeted advertising system of claim 9, further comprising an audio signal processor for extracting voice sources from the subset of the plurality of viewers by processing the audible attributes sensed by the audio sensor.

14. The viewer-targeted advertising system of claim 13, wherein the audio signal processor utilizes Blind Source Separation.

15. The viewer-targeted advertising system of claim 13, wherein the audio signal processor further determines location information for the extracted voice sources, and further uses the determined location information to cluster sets of extracted voice sources, each clustered set of extracted voice sources being associated with a subset of the plurality of viewers.

16. The viewer-targeted advertising system of claim 13, further comprising a speech-to-text converter for converting speech patterns from the extracted voice sources to text.

17. The viewer-targeted advertising system of claim 16, wherein the statistical modeling module further identifies one or more keywords in the converted text, the keywords correlating to one or more demographics.

18. The viewer-targeted advertising system of claim 16, wherein the statistical modeling module further identifies one or more keywords in the converted text, the determined one or more representative demographics being defined at least in part by a subset of the identified one or more keywords.

19. The viewer-targeted advertising system of claim 9, including a computer vision module for processing a signal received from the visual sensor to determine physical attributes, including an approximation of at least one of the set consisting of clothing, gender, age, ethnicity, height, and weight.

20. The viewer-targeted advertising system of claim 19, wherein the computer vision module includes probabilistic logic to determine the approximation of the at least one of the set consisting of clothing, gender, age, ethnicity, height, and weight.

21. The viewer-targeted advertising system of claim 9, wherein the statistical modeling module utilizes Bayesian logic to determine the one or more representative demographics.

22. The viewer-targeted advertising system of claim 9, wherein the statistical modeling module uses heuristic logic to determine the one or more representative demographics.

23. The viewer-targeted advertising system of claim 9, wherein the statistical modeling module, in conjunction with determining the one or more representative demographics, associates a statistical weighting with each of a plurality of potential demographics, each statistical weighting representing a probability that the associated potential demographic accurately represents the subset of the plurality of viewers.

24. The viewer-targeted advertising system of claim 9, wherein the statistical modeling module further determines an approximate number of persons comprising the subset of the plurality of viewers by using at least one attribute of the subset of the plurality of viewers.

25. A method for targeting advertising to a plurality of viewers proximate to an advertising display, the advertising display for displaying advertisements from a database of advertisements, the method comprising:
determining one or more attributes of a subset of the plurality of viewers, the one or more attributes selected from physical attributes and audible attributes of the subset of the plurality of viewers;
determining one or more representative demographics of the subset of the plurality of viewers, the one or more representative demographics being associated with at least one of the determined attributes of the subset of the plurality of viewers;
selecting one or more advertisements from the database of advertisements associated with the determined one or more representative demographics of the subset of the plurality of viewers; and
displaying the one or more selected advertisements on the advertising display for the plurality of viewers.

26. The method of claim 25, wherein the determining of the one or more representative demographics occurs even when the subset of the plurality of viewers are not taking purposeful action to direct the selecting of the one or more advertisements.

27. The method of claim 25, wherein the displaying of the one or more selected advertisements occurs substantially contemporaneously with the determination of the one or more attributes of the subset of the plurality of viewers.

28. The method of claim 25, wherein the determining of the one or more attributes further comprises processing at least one audio signal received from one or more audio sensors to extract voice sources from the subset of the plurality of viewers.

29. The method of claim 28, wherein the processing utilizes Blind Source Separation.

30. The method of claim 28, wherein the processing further comprises determining location information for the extracted voice sources, and comprises using the determined location information to cluster sets of extracted voice sources, each clustered set of extracted voice sources being associated with a subset of the plurality of viewers.

31. The method of claim 28, wherein the processing further comprises converting speech patterns from the extracted voice sources to text.

32. The method of claim 31, wherein the determining of the one or more representative demographics further comprises identifying one or more keywords in the converted text, the keywords correlating to one or more demographics.

33. The method of claim 31, wherein the determining of the one or more representative demographics further comprises identifying one or more keywords in the converted text, the determined one or more representative demographics being defined at least in part by a subset of the identified one or more keywords.

34. The method of claim 25, wherein the determining of the one or more attributes further comprises processing a signal received from a visual sensor to determine one or more physical attributes of the subset of the plurality of viewers, the determined physical attributes including an approximation of at least one of the set consisting of clothing, gender, age, ethnicity, height, and weight.

35. The method of claim 34, wherein the processing further comprises using probabilistic logic to determine the approximation of the at least one of the set of clothing, gender, age, ethnicity, height, and weight.

36. The method of claim 25, wherein the determining of the one or more representative demographics comprises applying heuristic logic to the one or more determined attributes of the subset of the plurality of viewers to generate the one or more representative demographics of the subset of the plurality of viewers.

37. The method of claim 25, wherein the determining of the one or more representative demographics comprises applying Bayesian logic to the one or more determined attributes of the subset of the plurality of viewers to generate the one or more representative demographics of the subset of the plurality of viewers.

38. The method of claim 25, wherein the determining of the one or more representative demographics further comprises associating a statistical weighting with each of a plurality of potential demographics, each statistical weighting representing a probability that the associated potential representative demographic accurately represents the subset of the plurality of viewers.

39. The method of claim 25, further comprising determining an approximate number of persons comprising the subset of the plurality of viewers by using at least one of the determined attributes of the subset of the plurality of viewers.
